(19) United States
(12) Patent Application Publication
(10) Pub. No.: US 2003/0182167 A1
(43) Pub. Date: Sep. 25, 2003

(54) Goal management

(76) Inventors: Wolfgang Kalthoff, Bad Schonborn (DE); Thomas Vogt, Romerberg (DE); Guenter Huber, Oberkirch (DE); Guido Hoeckele, Knittlingen (DE); Amra Catic, Karlsruhe (DE); Adam Polly, Stutensee (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/307,905

(22) Filed: Dec. 2, 2002

Related U.S. Application Data
(60) Provisional application No. 60/367,397, filed on Mar. 21, 2002.

(51) Int. Cl. G06F 17/60

(52) U.S. Cl. 705/7

(57) ABSTRACT

Methods and apparatus implementing a technique for managing goals. The technique includes storing at least one goal related to an entity, storing an entity structure, linking at least one stored goal to at least one associated component of the entity structure, providing a user with access to each associated goal of each component through access to one or more components of the entity structure, and providing the user with access to each component associated with a goal through access to the goal.

### CROSS-REFERENCE TO RELATED APPLICATIONS

This application claims priority based on Provisional U.S. Patent Application No. 60/367,397 for MASTER DATA MANAGEMENT, filed Mar. 21, 2002, the disclosure of which is incorporated here by reference in its entirety.

### BACKGROUND

The present invention relates to data processing, and more particularly, to goal management systems.

An important factor in the success of businesses in the current era is the ability to flexibly react to the requirements of the market. For example, shorter product cycles require decreased product development times and quicker introduction to market while increased customer demands for individual solutions increases the number of variants. The global orientation and increasing cost pressure can result in businesses receiving an increasingly greater portion of products or services from a subcontractor or a development partner.

These factors require businesses to be able to proceed simultaneously with the definition of the requirements and structure as well as the introduction of collaborative processes during communication with the subcontractors and development partners. New products or services are introduced rapidly to market based on internally and externally defined requirements. The requirements can be developed into goals for products and services.

Product structure or service components need to be evaluated in view of the goals. A product structure can include all objects in a product creation process. Other entities in which components can be evaluated in view of goals include marketing, organizations, a project management and a human resources.

When changes are made to product structure or entity structure, analysis needs to be performed to determine how the changes will affect the goals. For example, impact analysis can be performed to determine how a change to a part of a product structure will affect the overall product structure and goals associated with the product structure.

The changes made by one collaborator can affect structure parts that are in the control of another collaborator. A user performing changes needs to determine what other parts of a project are be affected by the changes. New evaluations need to be performed to ensure that goals are met. If the goals are not met, the goals may need to be modified in view of the changes to the product or entity structure.

### SUMMARY OF THE INVENTION

The present invention provides methods and apparatus, including computer program products, for goal management.

In general, in one aspect, the invention features methods and apparatus implementing a technique for managing goals. The technique includes storing at least one goal related to an entity, storing an entity structure, linking at least one stored goal to at least one associated component of the entity structure, providing a user with access to each associated goal of each component through access to one or more components of the entity structure, and providing the user with access to each component associated with a goal through access to the goal.

Particular implementations can include one or more of the following features. The technique can include allowing verification of one or more components of the entity structure based on the associated stored goals. Each entity structure can be divided into variant structures, and goals related to each of the variant structures can be stored. Goals specific to each of the variant structures can also be defined and stored.

A user can perform impact analysis on the stored entity structure based on changes to the stored goals. The entity structure can include a marketing structure, a product structure, an organizational structure, a project management structure or a human resources structure.

The stored goals can be updated. The stored goals can be derived from requirements or constraints. A goal can be derived for a component from at least one stored goal linked to the component, and the derived goal can be stored with the component. A user can be allowed to access goals and associated components to perform change management, configuration management, collaboration and/or workflow processes. A report on goal fulfillment can be generated. A list of goals and associated components can be generated in response to user input. The user input can include a text search, a category search, an attribute search, or a relational search. Verification and test data can be linked to goal and product structures. At least one component of the entity structure can be linked to one or more associated goals.

In general, in another aspect, the invention features methods and apparatus implementing a system for managing goals. The system includes a database and a goal management tool. The database has a plurality of sections including a first storage section and a second storage section. The first storage section stores goal information for a product structure. The second storage section stores component information of a product structure, where the goal information is linked to related component information. The goal management tool presents a user with related component information for each goal and related goal information for each component of the product structure.

Particular implementations can include one or more of the following features. The goal management tool can include a verification element. The verification element allows a user to verify derived goals stored with the component information against linked goal information. The goal management tool can also include a reporting element allowing a user to report on goal fulfillment. The goal management tool can be integrated into a project management systems, a human resources management system, an engineering change management system, a strategic enterprise management system, a business intelligence system, a reporting system, an enterprise resource management system, and/or a quality management system.

The invention can be implemented to realize one or more of the following advantages. Mapping goals to product structure allows a user to navigate between components of the product structure and goals associated with the components of the product structure. Navigating between the product structure and the goals will allow a user to find what goals will be affected by changes to the product structure, and what other parts of the product structure would be affected by changes to the goals. The user will not need to determine what goals would be relevant to changes being contemplated, and the user will not need to independently track down those goals.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram illustrating a data management system.

FIG. 2 is a block diagram illustrating an implementation of a data store in an entity of a data management system.

FIG. 3 is a block diagram illustrating an implementation of a goal store in a data management system.

FIG. 4 is a block diagram illustrating an implementation of a goal management system in a data management system.

FIG. 5 is a flow diagram illustrating an implementation of a method for managing goals in a data management system.

Like reference numbers and designations in the various drawings indicate like elements.

### DETAILED DESCRIPTION

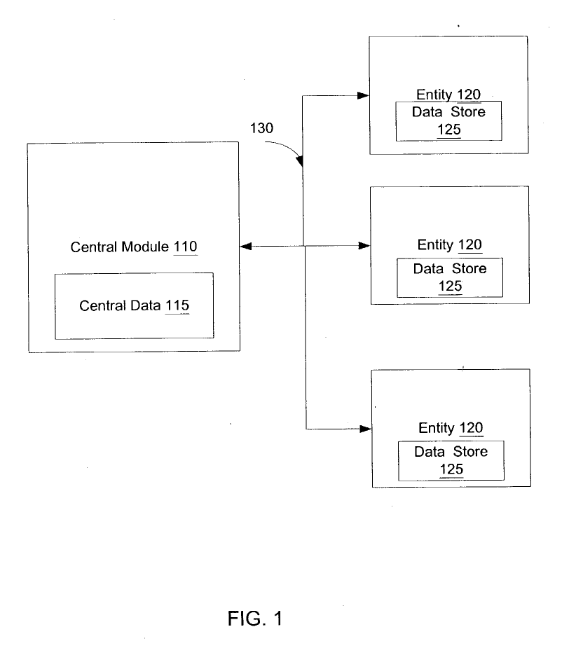

As shown in FIG. 1, a goal management system can be implemented in a data management system 100. The data management system 100 includes a central module 110 and entity modules 120. Each of the modules 110, 120 includes a data store 115, 125. The data management system 100 can include a product creation system, a project management system, a human resources management system or any other system in which data and goals are shared by a plurality of entities. The data management system 100 will be described with reference to a product creation system.

The central module 110 represents a centralized control for the data management system 100. The entity modules 120 represent entities involved in the data management system. For example, the entity modules 120 can represent entities involved in a product creation process. Many entities can participate in the development of a product.

The entities can include internal and external entities. For example, entity modules 120 can include modules for design, engineering, testing, purchasing, marketing, sales, manufacturing, installation, customer service, technical services, customers, dealers, distributors, suppliers, vendors, and regulatory organizations. The central module 110 and the entity modules 120 can communicate through a network 130.

The central module 110 includes a central data store 115 that stores master data for a product creation process. The central data can be accessed by the entity modules 120, based on permissions, or transmitted to the entity modules 120 through network 130. Each of the entity modules 120 includes a data store 125 for storing the data received from the central module 110 and for additional entity specific data developed in entity module 120. For example, if the entity module 120 is a marketing module, the corresponding data store 125 can store marketing specific information. The entity specific data can be transmitted to the central data store 115.

Data for the product creation process can be stored in records in the data stores 115, 125. The data includes objects associated with the product creation process. These objects can include requirements, product classes, attributes, product line designs, parts lists, materials lists, quality characteristics, and product structures. The objects associated with the product creation process can be organized in the data store with relation to products, product lines, and classes of products.

The entity modules 120 can develop objects of the product creation process in parallel. Each entity module 120 can develop different versions of each object of the product creation process. Thus, one or more of the entity modules 120 can change a product structure of a product stored in central module 110.

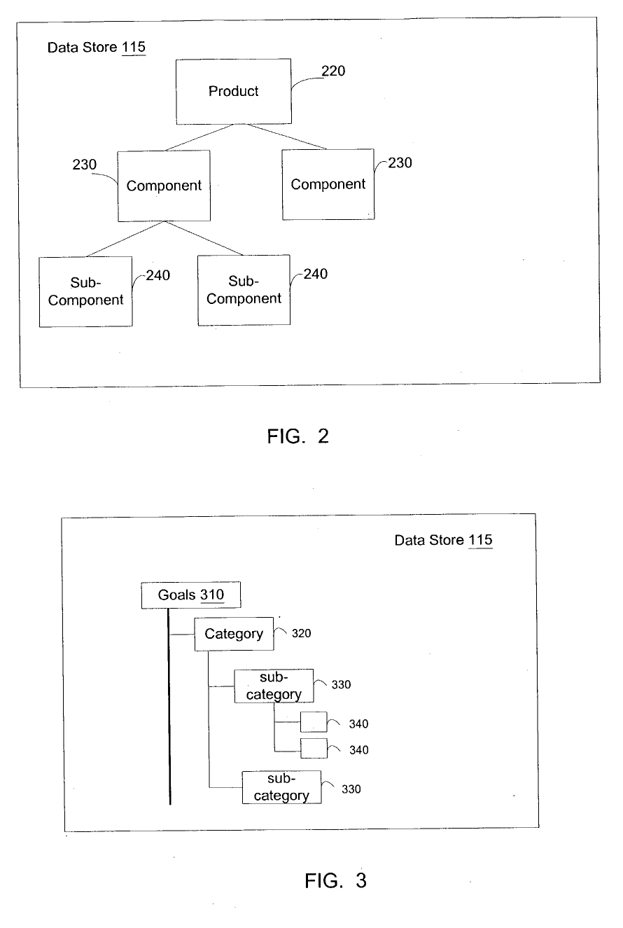

FIG. 2 is a block diagram illustrating an implementation of a product structure 220 stored in a data store 115, 125. The product structure 220 can be arranged in a variety of ways. In one implementation, the product structure 220 can be organized in a hierarchical structure, as shown. The product associated with the product structure 220 can include a specific product or a product line. The product structure 220 can include one or more components 230. Components 230 can include parts of the product structure or services. Each component 230 can include one or more sub-components 240 of a component 230. Each sub-component 240 can include further sub-components (not shown). For example, if the product 220 is a car, a component 230 can include the body of the car, and a sub-component 240 can include the roof of the car.

The product structure 220 can also include variant structures for each component 230 or sub-component 240. For example, if a component 230 is a brake for a car, the variant structures can include (1) Disc and (ABS or EDS or SER), (2) Drum and SER, and (3) Drum and (ABS or EDS).

FIG. 3 is a block diagram illustrating an implementation of a goal store in a data management system 100. Referring now to FIGS. 1 and 3, goals 340 can be developed in central module 110 and entity modules 120 and stored in a goals record 310. The goals 340 can be developed based on collected ideas and information, and analysis of product portfolios. The goals 340 can be used to develop the product structure 220. The goals 340 can include scalar quantities or documents.

The goals record 310 can include a hierarchical structure, organizing the goals record 310 into categories 320 and sub-categories 330. The goals record 310 can also include a network structure. The goals 340 can be stored at any level of the goals record 310. For example, if the product is a notebook computer, the categories 320 of goals record 310 can include weight, life, technology and design. The category technology can include sub-categories 330 CPU and memory.

Goals 340 can be stored in any of the categories 320 or sub-categories 330. Goals 340 can be derived from requirements or constraints defined during a product creation process by different entities involved in the product creation process. For example, a requirement for a car can include gas mileage of 30 m.p.g. (miles per gallon). This requirement can be transformed into a goal 340 for new car designs. The requirements and constraints can be defined in any of the entity modules 120.

The goals 340 can be used to develop a concept structure, which can be developed further into the product structure 220. A concept structure is a design structure that can be developed during a design stage of a product creation process. A concept structure can include the culmination of goals 340. The concept structure can have a similar structure to the product structure 220. The discussion relating to managing goals 340 in relation to product structure 220 can be also be applied to managing goals in relation to concept structure.

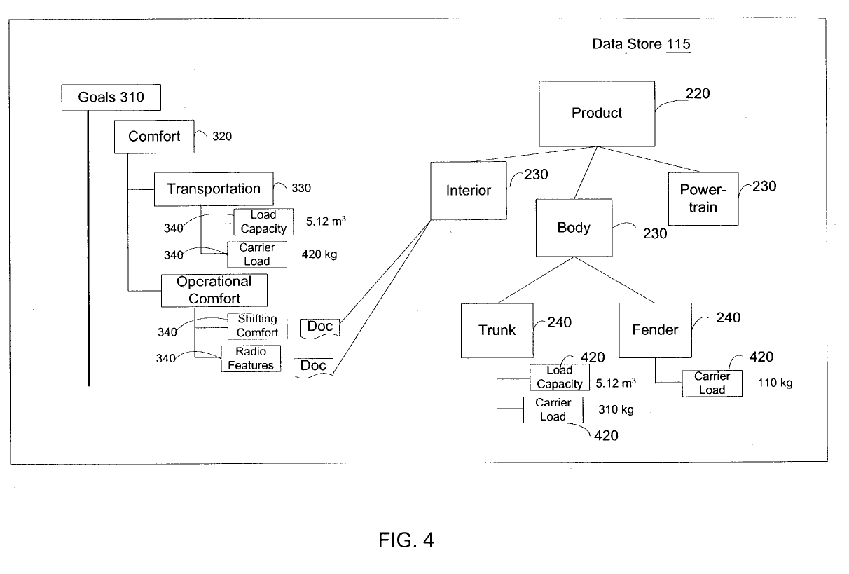

FIG. 4 is a block diagram illustrating a mapping of goals 340 in a goals record 310 to a product structure 220. In the example shown, the product is a car. Some of the components 230 of the car can include interior, body and power train. The body component 230 can include sub-components 240 trunk and fender.

The goals record 310 includes a category 320 of comfort, and sub-categories 330 transportation and operational comfort. The goals 340 under the sub-category 330 of operational comfort include shifting comfort and radio features. As shown, the documents associated with the goals 340 under operational comfort are linked to the interior component 230 of the car structure.

The transportation sub-category 330 includes goals 340 including a load capacity of 5.12 m³ and a carrier load of 420 kg. The goal for load capacity is linked to the sub-component trunk, which has a derived goal 420 for load capacity based on the load capacity goal 340 stored in goals record 310. The carrier load goal 340 has corresponding derived goals 420 associated with the sub-components 240 trunk and fender. As shown, the derived goal 420 for carrier load associated with the sub-component trunk is 310 kg. The derived goal 420 for carrier load associated with the sub-component fender is 110 kg.

The goals 340 stored in goals record 310 are mapped to the components 230 and sub-components 240, and the derived goals 420, of the product structure 220 through links between the goals 340 and parts of the product structure 220. The goals 340 can also be mapped to each variant structure of the components 230 and sub-components 240. The mappings allow navigation between the components 230 and sub-components 240 of the product structure 220 and goals associated with the components 230 and sub-components 240.

The goal to product structure mapping can be a part of an IT (information technology) tool. Users can use the IT tool to determine what goals 340 are affected by changes to product structure 220. A user accessing the product structure 220 through the IT tool can navigate to all goals associated with each component 230 and sub-component 240 of the product structure 220. The IT tool can include a user interface (“UI”) to display the product structure record 220 shown in FIG. 2. The product structure record 220 can include UI controls allowing navigation from a component 230 or sub-component 240 to the associated goals 340. Each associated goal 340 can also include indications of what other components 230 or sub-components 240 of the product structure are affected by changes to components 230 or sub-components 240 associated with the goal 340. The indications of what other components 230 or sub-components 240 affected can include UI controls that allow the user to navigate to the associated components 230 and sub-components 240.

Users of the IT tool can include, for example, vendors determining impact of changes on delivery date, designers of the product adding requirements to a next version of the product or a maintenance department determining what the impact of maintenance will be on the life cycle of the product.

The IT tool can be used to support the whole lifecycle of all structures and data involved in a product creation process. For example, the IT tool can be used to support change management, configuration management, collaboration between entities 120 and internal and external workflow processes. Change management can include product structure history log, status management, and baseline product structures (saved product structures representing product designs upon which changes are made).

In the change management example, a user making a change to a component 230 of product structure 220, can access all goals 340 that are associated with the component 230. The user can also determine what other components that are affected by changes related to the goals 340 associated with the component 230 being changed.

The IT tool can also allow for reporting on goal fulfillment (goal tracking). For example, a listing of a set of goals 340 can be put into a report along with data regarding all components 230 and sub-components 240 related to the set of goals.

The IT tool can further allow users to search for goals and their related structures using text search, category search, attribute search, and/or relational search. Linking and tracking (searching) of verification and test data to goal and product structures can also be performed using the IT tool. The IT tool can be integrated into project management systems, human resources management systems, engineering change management systems, strategic enterprise management systems, business intelligence systems, reporting systems, enterprise resource management systems, and/or quality management systems.

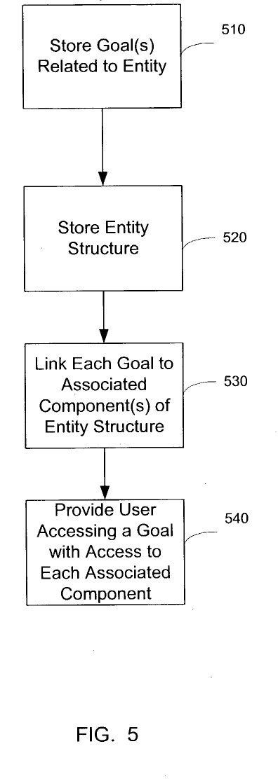

FIG. 5 is a flow diagram illustrating an implementation of a method for managing goals in a data management system. Referring to FIGS. 1,2,3 and 5, at step 510, goals 340 related to an entity are stored in a data store 115, 125. The goals 340 can be stored according to categories 320 and sub-categories 330. The step of storing goals 340 can also include updating stored goals 340.

At step 520, an entity structure is stored in a data store 115, 125. The entity structure can include a product structure 220, a marketing structure, an organizational structure, a project management structure or a human resources structure. The method of managing goals will be discussed with reference to a product structure 220.

The product structure 220 can be stored in a hierarchical structure including components 230 and/or sub-components 240. The product structure can also include variants of the components 230 and/or sub-components 240.

If the goals 340 and/or product structure 220 are stored in an entity data store 125, the goals 340 and/or the product structure 220 are also transmitted to the central data store 115 for long-term storage.

At step 530, goals 340 are linked to one or more of the components 230 and/or sub-components 240, and variants of each. Some goals 340 can link to more than one part of the product structure, while some parts of the product structure may not link to any goal. The links between the goals 340 and the parts of the product structure 220 allow navigation between parts of the product structure 220 and goals associated with the parts of the product structure 220. Navigation between the goals 340 and components 230 and/or sub-components 240 of the product structure 220 provides traceability between the product structure 220 and its associated goals.

The user can use the navigation capability to perform verification of the components 230 and/or sub-components 240, and changes to the component 230 and/or sub-components 240, based on the associated goals 340. The user can also use the navigation capability to perform impact analysis for changes to the product structure 220.

At step 540, a user accessing a goal 340 is provided with access to each associated component 230 or sub-component 240 of a product structure. The user accessing a component 230 or sub-component 240 is also provided with access to each associated goal of the component 230 or sub-component240. A user can be provided with access to the goals or components 230 and sub-components 240 through UI controls representing links from the goals record 310 to the product structure 220.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results. The invention can be used in any system or entity having goals.

What is claimed is:

1. A method of managing goals, comprising:
storing at least one goal related to an entity;
storing an entity structure;
linking at least one stored goal to at least one associated component of the entity structure;
providing a user with access to each associated goal of each component through
access to one or more components of the entity structure; and
providing the user with access to each component associated with a goal through access to the goal.

2. The method of claim 1, wherein providing the user with access to each associated goal and providing the user with access to each component includes:
allowing verification of one or more components of the entity structure based on the associated stored goals.

3. The method of claim 1, further comprising dividing each entity structure into variant structures and storing goals related to each of the variant structures.

4. The method of claim 3, further comprising defining and storing goals specific to each of the variant structures.

5. The method of claim 1, further comprising allowing a user to perform impact analysis on the stored entity structure based on changes to the stored goals.

6. The method of claim 1, wherein storing the entity structure includes:
storing a marketing structure.

7. The method of claim 1, wherein storing the entity structure includes:
storing a product structure.

8. The method of claim 1, wherein storing the entity structure includes:
storing an organizational structure.

9. The method of claim 1, wherein storing the entity structure includes:
storing a project management structure.

10. The method of claim 1, wherein storing the entity structure includes:
storing a human resources structure.

11. The method of claim 1, further comprising updating the stored goals.

12. The method of claim 1, further comprising deriving the stored goals from requirements or constraints.

13. The method of claim 1, further comprising deriving a goal for a component from at least one stored goal linked to the component, and storing the derived goal with the component.

14. The method of claim 1, further comprising allowing the user to access goals and associated components to perform at least one of change management, configuration management, collaboration and workflow processes.

15. The method of claim 1, further comprising generating a report on goal fulfillment.

16. The method of claim 1, further comprising generating a list of goals and associated components in response to user input, the user input including one of a text search, a category search, an attribute search, and a relational search.

17. The method of claim 1, further comprising linking verification and test data to goal and product structures.

18. The method of claim 1, further comprising linking at least one component of the entity structure to one or more associated goals.

19. A computer program product, tangibly stored on a computer-readable medium, the computer program product comprising instructions operable to cause a programmable processor to:
store at least one goal related to an entity;
store an entity structure;
link at least one stored goal to at least one associated component of the entity structure;
provide a user with access to each associated goal of each component through access to one or more components of the entity structure; and
provide the user with access to each component associated with a goal through access to the goal.

20. The computer program product of claim 19, wherein the instructions operable to cause a programmable processor to provide the user with access include instructions operable to cause a programmable processor to:
allow verification of one or more components of the entity structure based on the associated stored goals.

21. The computer program product of claim 19, further comprising instructions operable to cause a programmable processor to divide each entity structure into variant structures and store goals related to each of the variant structures.

22. The computer program product of claim 21, further comprising instructions operable to cause a programmable processor to define and store goals specific to each of the variant structures.

23. The computer program product of claim 19, further comprising instructions operable to cause a programmable processor to allow a user to perform impact analysis on the stored entity structure based on changes to the stored goals.

24. The computer program product of claim 19, wherein the instructions operable to cause a programmable processor to store the entity structure include instructions operable to cause a programmable processor to:
store a marketing structure.

25. The computer program product of claim 19, wherein the instructions operable to cause a programmable processor to store the entity structure include instructions operable to cause a programmable processor to:
store a product structure.

26. The computer program product of claim 19, wherein the instructions operable to cause a programmable processor to store the entity structure include instructions operable to cause a programmable processor to:
store an organizational structure.

27. The computer program product of claim 19, wherein the instructions operable to cause a programmable processor to store the entity structure include instructions operable to cause a programmable processor to:
store a project management structure.

28. The computer program product of claim 19, wherein the instructions operable to cause a programmable processor to store the entity structure include instructions operable to cause a programmable processor to:
store a human resources structure.

29. The computer program product of claim 19, further comprising instructions operable to cause a programmable processor to update the stored goals.

30. The computer program product of claim 19, further comprising instructions operable to cause a programmable processor to derive the stored goals from requirements or constraints.

31. The computer program product of claim 19, further comprising instructions operable to cause a programmable processor to derive a goal for a component from at least one stored goal linked to the component, and store the derived goal with the component.

32. The computer program product of claim 19, further comprising instructions operable to cause a programmable processor to allow the user to access goals and associated components to perform at least one of change management, configuration management, collaboration and workflow processes.

33. The computer program product of claim 19, further comprising instructions operable to cause a programmable processor to generate a report on goal fulfillment.

34. The computer program product of claim 19, further comprising instructions operable to cause a programmable processor to generate a list of goals and associated components in response to user input, the user input including one of a text search, a category search, an attribute search, and a relational search.

35. The computer program product of claim 19, further comprising instructions operable to cause a programmable processor to link verification and test data to goal and product structures.

36. The computer program product of claim 19, further comprising instructions operable to cause a programmable processor to link at least one component of the entity structure to one or more associated goals.

37. A system for managing goals, comprising:
a database having a plurality of sections including
a first storage section storing goal information for a product structure, and
a second storage section storing component information of a product structure, the goal information being linked to related component information; and
a goal management tool for presenting a user with related component information for each goal and related goal information for each component of the product structure.

38. The system of claim 37, wherein the goal management tool further includes a verification element allowing the user to verify derived goals stored with the component information against linked goal information.

39. The system of claim 37, wherein the goal management tool further includes a reporting element allowing the user to report on goal fulfillment.

40. The system of claim 37, wherein the goal management tool is integrated into at least one of a project management systems, a human resources management system, an engineering change management system, a strategic enterprise management system, a business intelligence system, a reporting system, an enterprise resource management system, and a quality management system.
